(19) United States
(12) Patent Application Publication
(10) Pub. No.: US 2009/0119103 A1
(43) Pub. Date: May 7, 2009

(54) SPEAKER RECOGNITION SYSTEM

(76) Inventors: Franz Gerl, Neu-Ulm (DE); Tobias Herbig, Ulm (DE)

Correspondence Address: HARMAN - BRINKS HOFER CHICAGO;Brinks Hofer Gilson & Lione, P.O. Box 10395, Chicago, IL, 60610, US

(21) Appl. No.: 12/249,089

(22) Filed: Oct. 10, 2008

(30) Foreign Application Priority Data
Oct. 10, 2007 (EP) 07019849.4

(51) Int. Cl. G10L 15/06; G10L 17/00

(52) U.S. Cl. 704/243; 704/246; 704/250; 704/E15.001; 704/E15.007

(57) ABSTRACT

A method automatically recognizes speech received through an input. The method accesses one or more speaker-independent speaker models. The method detects whether the received speech input matches a speaker model according to an adaptable predetermined criterion. The method creates a speaker model assigned to a speaker model set when no match occurs based on the input.

### BACKGROUND OF THE INVENTION

1. Priority Claim

This application claims the benefit of priority from European Patent 07019849.4 dated Oct. 10, 2007, which is incorporated by reference.

2. Technical Field

This disclosure is directed to a speaker recognition system that recognizes speech through speech input.

3. Related Art

Speaker recognition may confirm or reject speaker identities. When identifying speakers, candidates may be selected from speech samples. Some speech recognition systems degrade if not fully trained before use. Such system may require extensive training to sample and store a collection of voice files before it is used. Training is frustrating when systems require only fluent, long, well articulated phrases. When mistakes occur, some systems repeat these errors when processing speech. There is a need for a reliable system that may minimize some of the frustration associated with some voice recognition systems.

### SUMMARY

A system automatically recognizes speech based on a received speech input. The system includes a database that retains a speaker model set comprising a speaker model that is speaker-independent. A detecting component detects whether the received speech input matches a speaker model according to an adaptable predetermined criterion. A creating component creates a speaker model assigned to the speaker model set based on the received speech input when no match is detected.

Other systems, methods, features, and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an automatic speech recognition process.

FIG. 2 is a process that detects a speaker change.

FIG. 3 is a process that identifies and selects speaker models.

FIG. 4 is a speech recognition system.

FIG. 5 is a speech recognition system interfacing a vehicle.

FIG. 6 is a speech recognition system interfacing an audio system and/or a communication system.

FIG. 7 is an alternate speech recognition system.

FIG. 8 is an alternate speech recognition system.

FIG. 9 is a speech recognition process.

FIG. 10 is a Maximum A Posteriori adaptation.

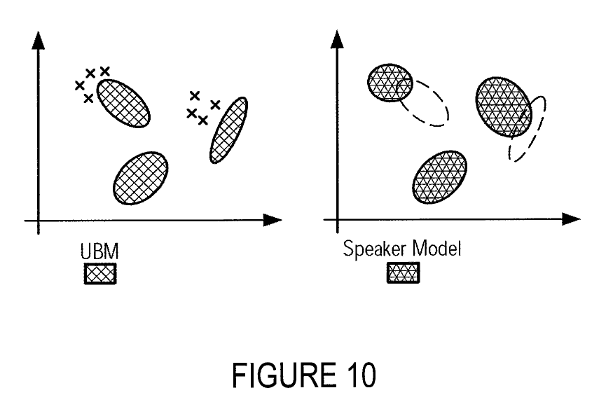

### DETAILED DESCRIPTION OF THE PREFERRED EMBODIMENTS

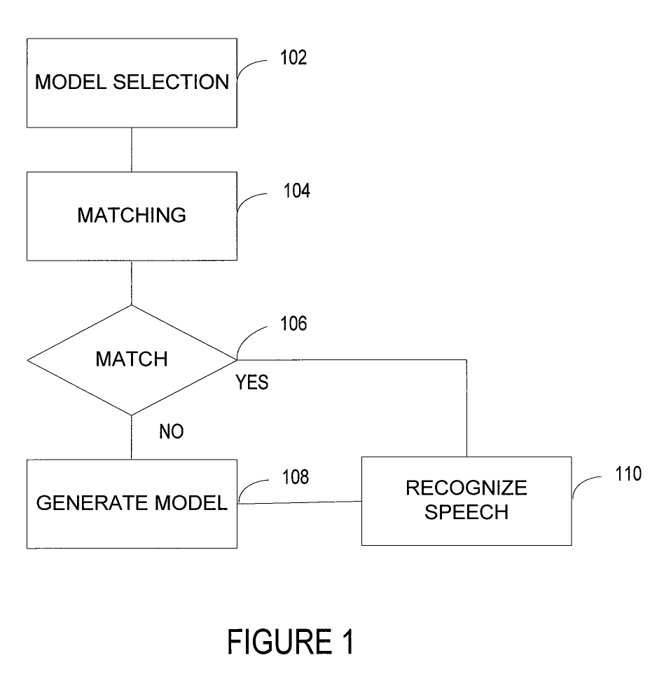

An automatic speech recognition system enhances accuracy and improves reliability through models that may account for known and/or inferred properties of a user's voice. The systems select one or more speaker models when speech input substantially matches one or more stored models at 102 (see FIG. 1). Some systems may establish a match through a predetermined criterion at 104. When no matches are found at 106, the automatic speech recognition system may create one or more speaker models 108 based on a received input at that may identify the speech at 110.

Some user created speaker models are speaker-dependent. At start-up a system may include one or more speaker-independent models. Through use the systems may generate and retain speaker-dependent models in one or more local or remote memories. Speaker-dependent models may be created without advanced voice training. When other speakers use the system (e.g., more than one speaker) some systems create differentiable speaker-dependent models.

Predetermined criterion may be a fixed or adaptable and may be based on one or more variables or parameters. The predetermined criterion may be programmed and fixed during one or more user sessions. Some predetermined criterion may change with a speaker's use or adapt to a speaker's surroundings or background noise. An exemplary predetermined criterion may be generated by interconnected processing elements that process a limited number of inputs and interface one or more outputs. The processing elements are programmed to ‘learn’ by processing weighted inputs that, with adjustment, time, and repetition may generate a desired output that is retained in the local or remote memories (or databases). Other exemplary predetermined criterion may be generated by a type of artificial-intelligence system modeled after the neurons (nerve cells) in a biological nervous system like a neural network.

Some systems select a speaker model or establish a match when the system detects a speaker change (e.g., a speaker change recognition). When change occurs, the system may discern the differences and select or modify the static or fluid predetermined criterion. A speaker change characteristic or measure may be an indication of the probability or the likelihood that one speaker has spoken throughout a session. In some applications, the systems measure a speaker change through a probability function or a conditional probability function. In other applications the predetermined criterion may be based on criteria unrelated to speaker change or a combination of a detected change and other criteria.

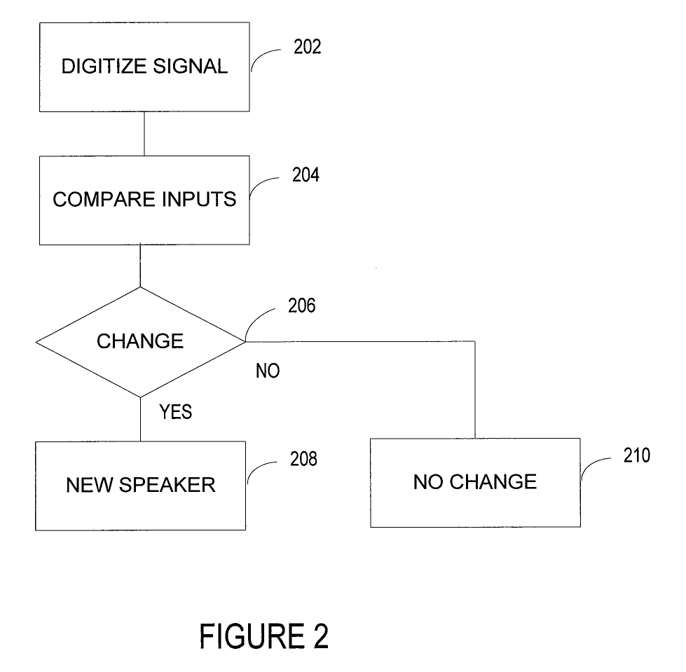

Systems may detect speaker changes as voice input is received or when the input is converted into a continuous or discrete signal at 202 (see FIG. 2). The detection may occur as the speech input (or utterance) is received and processed and/or as a preceding speech input is processed. When relatively short utterances or speech inputs (e.g., shorter than 3 seconds) are received, some systems compare a preceding speech input (that was buffered or stored) with a current speech input at 204. Some systems identify speaker change at 206-210 by processing two consecutive speech segments that may be locally buffered or remotely stored. The speech segments may be part of a received speech input; alternatively, the received speech input may be designated as one speech segment and a preceding speech input may be designated a second speech segment.

Some systems select a speaker model or establish a match when the system measures speaker identification. The state or characteristics of a speaker that may identify a user may affect or determine the predetermined criterion. In some systems a speaker identification measure is an indication of how well a received speech input matches a speaker model. The model may be part of a (speaker model) set. The identification may be a value below which a given proportion of the characteristics of the received speech input and a speaker model fall. The measure may be characterized through distributions, percentiles, quartiles, quantiles, and/or fractiles. In other systems, the identification may indicate a likelihood (or probability) that a received speech input matches a speaker model. A speaker identification measure may be a probability function such as a conditional probability function, for example.

Some systems measure speaker identification with respect to one or more speaker models that may be part of a speaker model set (e.g., it may include an entire speaker model set). A predetermined criterion may be based on some or all speaker identification measures. Each automatic speech recognition system may process or apply one or more models. The models may include one or more Support Vector Machines (SVM), Hidden Markov Models (HMM), Neural Networks (NN), Radial Basis Functions (RBF), and variations and combinations of such systems and models. In alternative automatic speech recognition systems, a speaker model may be a Gaussian mixture model such as diagonal covariance matrices.

A predetermined criterion may be based on other metrics. Some predetermined criterion measure speaker change and speaker identities or identification. The metrics are combined into a common model; in other systems, the metrics are distributed amongst two or more models. Processors may generate and execute the models that may be based on a Gaussian mixture or known or inferred properties of speech (e.g., voiced and unvoiced).

Some automatic speech recognition systems select speaker models and/or establish a match based on a Maximum A Posteriori (MAP) estimate. A system may recognize a speaker change by executing a Maximum A Posteriori (MAP) estimate too. Alternative systems may execute alternative estimates such as a Maximum Likelihood process or an Expectation Maximization (EM) process, for example.

Recognizing a speaker change may comprise adapting the speaker-independent model to two or more consecutive speech segments and to a unification of the speech segments (or consecutive speech segments). One or more of the speech segments may be part of the received speech input. In some applications one or more of the speech segments may correspond to a current speech input and the remaining speech segment may correspond to a preceding input. A model selection or a match may occur through a Maximum A Posteriori process. In other systems, model selection and matching may occur through a statistical or a likelihood function.

When recognizing a change in speakers, a system may monitor an input interface and execute a likelihood function. The function may indicate the probability that a speaker changed. In some applications, a predetermined criterion may comprise or be based on a common value that indicates no change or two or more values that indicate a likelihood of a change or a likelihood of no change, respectively. A processor or controller may detect a match by executing a Bayesian Information Criterion (BIC). In some systems BIC is processed to determine speaker changes when processing a speech input or when comparing a speech input.

Some speaker identifications occur when the processor or controller executes a likelihood function that may indicate that a received speech input corresponding to a speaker model. The speaker model may be part of a speaker model set. Identification may occur through a statistical analysis that measures a likelihood that the received speech input corresponds to each speaker model in the speaker model set. In some applications the statistical analysis measures the likelihood that the received speech input corresponds to some or to each user created speaker model in a speaker model set. In some applications the predetermined criterion is based on the one or more determined likelihood functions that may be executed when speech is received.

When establishing a match or identifying a speaker, some systems compare one or more likelihood functions that correspond to a speech input with a predetermined threshold. In some applications the match or identification may comprise or include comparing one or more differences of likelihood functions with a predetermined threshold that is retained in a local or remote memory. If a likelihood function or a difference falls below the predetermined threshold, the system may determine that the speech input does not match the corresponding speaker model. If no match is found an unknown speaker may be identified and a new speaker model may be created.

Some speaker-independent models may include Universal Background Model (UBM). The UBM may be trained through two or more speakers and/or two or more utterances using a k-means or an EM algorithm. A processing of a UMB may identify speakers or create other models.

Some systems select a speaker model or establish a match when the system executes a feature extraction on the received speech input. The extraction may monitor and/or process a feature vector, pitch and/or signal-to-noise ratios, may process non-speech information (e.g., applications or technical device signals), and may segment speech. When segmenting, speech pauses may be removed and reliability increased.

When one or more speaker models are created, the system may adapt an existing speaker-independent model. During adaptation the system may execute a Maximum A Posteriori (MAP) process. The process may differentiate speaker classes (e.g., by gender) to reflect, account, and process the different frequencies and periodicity that may characterize or distinguish two or more speech classes.

In some systems, the processor or controller may adapt speaker models that belong to the speaker model set when a match is detected. By adapting existing models that are similar to speech input, the system may yield more accurate speaker representations. In some applications a new speaker dependent model may not be created. An existing speaker-dependent model may be replaced or archived because an updated or adapted speaker model is generated. When adapting a speaker-dependent model, the system may process characteristics associated with the speech input or prior model including characteristics that may indicate a change in speakers or a speaker identification characteristic. When processing or comparing predetermined criterion indicates a match is less than certain (e.g., below a confidence level or range), adaptation or changes in speaker-dependent models may be delayed. The length of the delay may be controlled by the receipt and processing of additional information.

A model adaptation may compare a speaker model that is a member of the speaker model set before and after a potential change. The comparison may determine the divergence or distances between each of the speaker models prior to or after the adaptation. Some systems may determine a Kullback-Leibler entropy. Other systems may execute a cross-correlation. By these exemplary analyses additional processes may be processed with the predetermined criterion to identify a match.

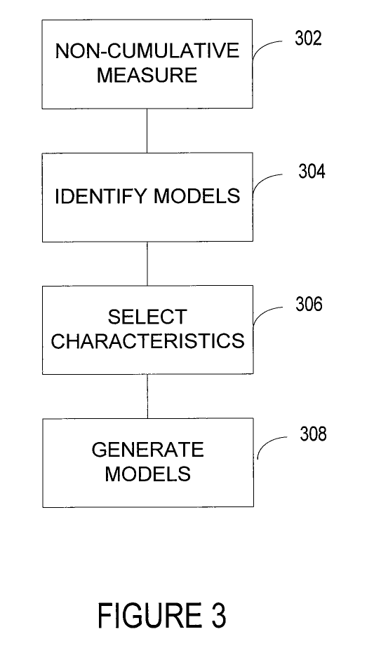

The systems described may further process two or more models that belong to a speaker model set. The systems may identify models at 304 when they correspond to a common speaker according to a predetermined criterion (see FIG. 3). In this application, a predetermined criterion may identify models through non-cumulative measures of differences, divergences, and/or distances at 302. A processor or controller may execute a Kullback-Leibler entropy analysis or a cross-correlation analysis, for example, between the speaker models. The processor or controller may combine elements or characteristics from two or more speaker models in some sessions to yield another (or different) model that may be assigned to a speaker model set at 306 and 308.

Some systems select a speaker model or establish a match when the system executes a similar non-cumulative measure of differences, divergences, and/or distances between two or more speaker models. A Kullback-Leibler entropy may be executed in this circumstance too. When more than one model corresponds to a common speaker they may be combined during this process.

Each of the above-described systems may account for or process undesirable changes in waveforms that occur during the transmission of speech or when the signals pass through the system that may result in a loss of information. To account or compensate for these conditions the system may detect, access, and process noise models such as a background noise model. The randomness or periodic nature of the disturbance may be recognized and compensated for (by a noise compensator) to improve the clarity of the speech input before or while the speech input is received and/or matched to one or more speech models. By this process, the system may improve system reliability and accuracy.

In some system a maximum number of speaker models that belong to a speaker model set may be predetermined (or fixed). By limiting the number of models, system efficiency may increase. In some application, when no match is detected and each of the speaker models that belong to a speaker model set are processed, the system may remove or archive one or more speaker models from a speaker model set according to a predetermined criterion. This predetermined criterion may be based on lifecycles, durations between adaptations and modifications of speaker models, quality metrics, and/or the content or size of the speech material that was processed during an adaptation.

Due to the dynamic and flexible nature of some automatic speech recognition systems including the use of different parameters or criterion to recognize a speaker, the system may process relatively short utterances (shorter than about 3 seconds) with high reliability. Reliability may be further improved by processing different parameters including indications of speaker changes and speaker identifications. Many systems may not rely on a strict threshold detection. Some systems may process or include more than one speaker-independent speaker model and differentiate speaker class to exploit known differences between users (e.g., gender) which may sustain the system's high reliability at a low bit rate.

An alternative system may process speech based on speaker recognition. In this alternative, different speech models and/or vocabularies may be processed, trained, and/or adapted for different speakers during use. When used to control in-vehicle or out-of-vehicle devices and/or a hands free communication devices (e.g., wireless telephones), the speaker models may be created at the same rate the data is received (e.g., in real-time). Some systems have limited users, in these applications system responsiveness and reliability may improve. In each application the automatic speech recognition systems may process utterances of short duration with an enhanced accuracy.

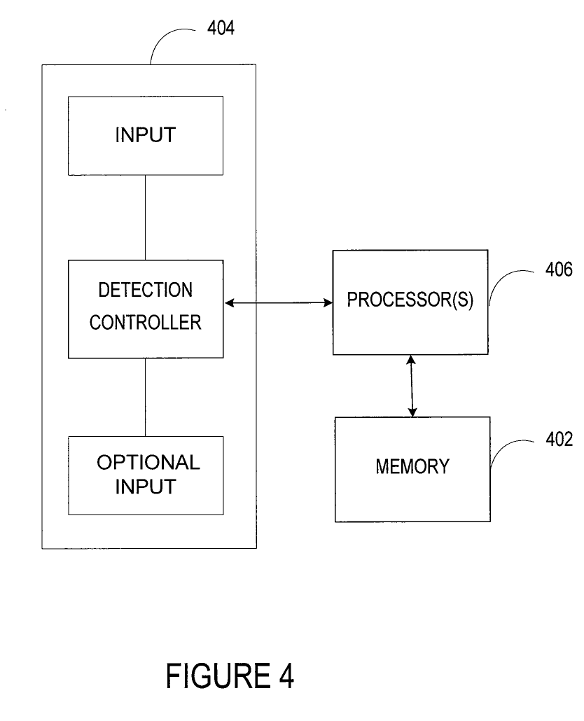

When interfaced to a computer readable storage medium the system may access and execute computer-executable instructions. The instructions may provide access to a local or remote central or distributed database or memory 402 (shown in FIG. 4) retaining one or more speaker models or speaker model sets. A speech input 404 (e.g., one or more inputs and a detection controller such as a beamformer) may be configured to detect a verbal utterance and to generate a speech signal corresponding to the detected verbal utterance. One or more processors (or controllers) 406 may be programmed to recognize the verbal utterance by selecting one or more speaker models when speech input substantially matches one or more of the stored models. Some processors may establish a match through one or more predetermined criterion retained in the database 402. When no matches are found the automatic speech recognition system may create and store one or more speaker models based on a received input. The processor(s) 406 may transmit the voice recognition through a tangible or virtual bus to a remote input, interface, or device.

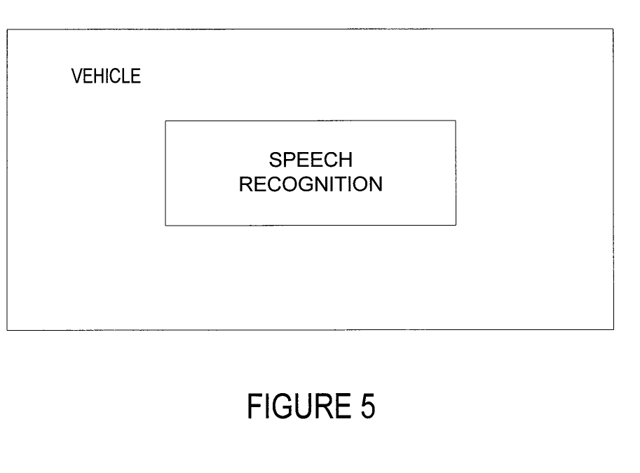

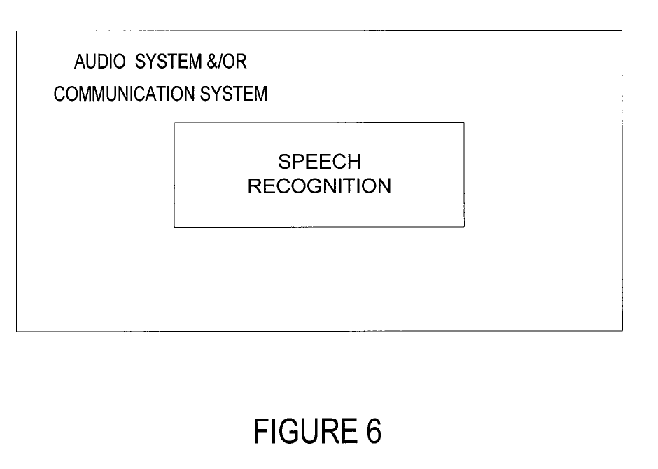

The processors or controllers 406 may be integrated with or may be a unitary part of an in-vehicle or out-of-vehicle system. The system may comprise a navigation system for transporting persons or things (e.g., a vehicle shown in FIG. 5), interface (or is a unitary part of) a communication (e.g., wireless system) or audio system shown in FIG. 6 or may be provide speech control for mechanical, electrical, or electro-mechanical devices or processes. The speech input may comprise one or more devices that convert sound into an operational signal. It may comprise one or more sensors, microphones, or microphone arrays that may interface an adaptive or a fixed beamformer (e.g., a signal processor that interfaces the input sensors or microphones that may apply weighting, delays, and/or etc. to combine the signals from the inputs). In some systems, the speech input interface 404 may comprise one or more loudspeakers. The loudspeakers may be enabled or activated to receive and/or transmit a voice recognition result.

An alternative automatic speech recognition system processes a received speech input and one or more speaker-independent speaker models. The system includes a first controller 702 that detects whether a received speech input matches a speaker model according to a predetermined criterion. When a match is not found, a second controller 704 may create and store a speaker model based on the received speech input. The speech models may be stored in a volatile or non-volatile local or remote central or distributed memory 706.

Predetermined criterion may be fixed or adaptable and may be based on one or more variables or parameters (e.g., including measuring speaker changes or a identifying speaker). The predetermined criterion may be programmed and fixed during one or more user sessions. Some predetermined criterion may change with a speaker's use or adapt to a speaker's surroundings or background noise. An exemplary predetermined criterion may be generated by interfacing the controllers 702 and/or 704 to interconnected processing elements that process a limited number of inputs and interface one or more outputs. The processing elements are programmed to ‘learn’ by processing weighted inputs that, with adjustment, time, and repetition may generate a desired output that is retained in the local or remote memories. Other exemplary predetermined criterion may be generated by a type of artificial-intelligence system modeled after the neurons in a biological nervous system like a neural network.

In some systems the first controller 702 includes, interfaces, or communicates with an optional speaker change recognition device 708 that is programmed or configured to identify and quantify when speakers changes. The value may be compared against a predetermined criterion that may validate or reject the device's 706 indication that a change in speakers occurred. In some systems, the first controller 702 may alternately, or in addition, include, interface, or communicate with an optional speaker identifying device 710. This device 710 may be programmed or configured to identify a speaker. Based on the identification a predetermined criterion or second predetermined criterion may be processed to confirm that speaker's identity.

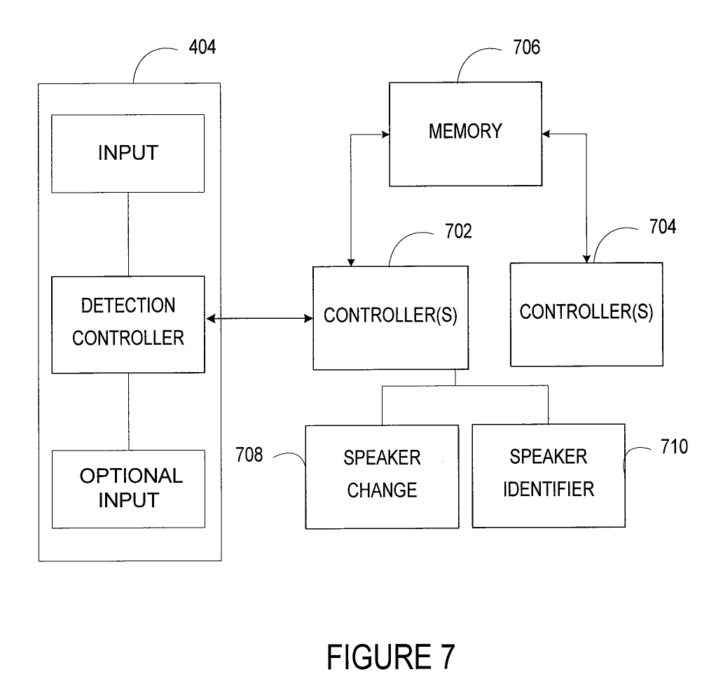

The system shown in FIGS. 4, 7, and 8 and processes of FIGS. 1-3, 5, 6, 8 and 9 may interface or may be a unitary part of a system or structure used to transport person or things. Devices that convert sound into continuous or discrete signals including one or more sensors, microphones, microphone arrays (with or without a beamformer) may convey data through the voiced and unvoiced signals. The signals may represent one or more type of utterances by one or more users. Some systems may successfully recognize speech made up of short utterances such as speech having a length of less than about 3 seconds.

To recognize speech, a speech input is received and subject to a feature extraction at 902. This process may be executed by a feature extraction component 802 (e.g., the use of the term component refers to system elements and devices). Through the feature extraction, features vectors, pitch, signal-to-noise ratio, and/or other data are obtained and transmitted to control component 804.

Feature vectors from the received speech input may be buffered at 904 (buffer 806). The buffer 806 may be accessed, read, and written to transfer information and data. Some systems limit the number of speech inputs to improve computational speed and ensure privacy. Other systems may limit the number of speech segments processed. In these systems only a predetermined number of utterances (e.g., five) are buffered. The size, frequency, and duration of the storage may depend on the desired accuracy and speed of the system. For the same reasons, other restrictions may also apply including restricting storage to consecutive utterances radiating from a common speaker.

A speaker change recognition process is executed by a speaker change recognition device 808. By a comparison of a current input with one or more prior inputs, a change in speakers may be detected at 906. A comparison of short-term correlations (e.g., the spectral envelope) and/or long term correlations (spectral fine structure) between the current and prior inputs may identify this change. Other methods may also be used including a multivariable Gauss Distribution with diagonal covariance matrix, an arithmetic harmonic sphericity measure, and/or support vector machines.

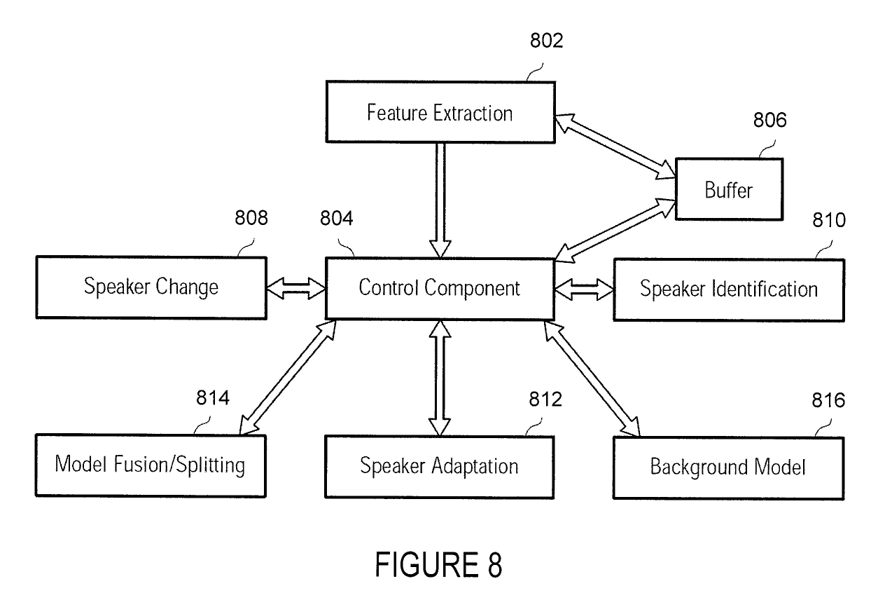

In one process, Gaussian mixture models (GMM) are used. Prior to processing, a speech independent GMM or a Universal Background Model (UBM) may be retained in an accessible local, remote, central and/or distributed memory. The UMB may be trained through a plurality of speakers and/or a plurality of utterances by a k-means or through an expectation maximization algorithm. These universal background models may be locally or remotely stored, and accessed by the components, devices, and elements shown in FIG. 8.

In general, a GMM comprises M Clusters, each consisting of a Gauss distribution N={x|μᵢ, Σᵢ} having a mean μ and a covariance matrix Σ. The feature vectors xₜ with time index t may be assumed to be statistically independent. The utterance is represented by a segment X={x₁, . . . , x_{M}} of length M. The probability density of the GMM is the result of a combination or superposition of all clusters with a priori probability p(i)=wᵢ. i is the cluster index and λ={w₁, . . . , w_{M}, μ₁, . . . , μ_{M}, Σ₁, . . . , Σ_{M}} represents the parameter set of the GMM.

The a posteriori probabilities are given by

$$p ( x \vert λ ) = {\sum }_{i = 1}^{M} {w}_{i} \cdot N \{ x \vert {μ}_{i} , {Σ}_{i} \}$$

$${\sum }_{i = 1}^{M} {w}_{i} = 1$$

The preceding utterance or utterances retained in buffer 806 may be represented by segment Y={Y₁, . . . , Y_{P}} of length P. This segment, depending on how many preceding utterances have been buffered, may correspond to a unification of a plurality of preceding utterances. A unified segment Z={X,Y} with length S=M+P may be provided which would correspond to the case of identical speakers for the preceding and the current utterances.

A Maximum A Posteriori method (MAP) may be executed to adapt the UBM to the segment of the current utterance, to the segment of the preceding utterance and to the unification of these two segments. A MAP process may be described in a general way. First, a posteriori probability p(i|x,λ) is determined. The posteriori probability corresponds to a probability that a feature vector x has been generated at time t by cluster i having the knowledge of the parameter λ of the GMM. Next, a relative frequency ŵ of the feature vectors in this cluster may be determined as their mean \hat{μ} and covariance \hat{Σ}. These may be processed to update the GMM parameters. In the equations below, nᵢ denotes the absolute number of vectors being assigned to cluster i by this process. In the following, only the weights and mean vectors of the GMM are adapted. This approach avoids the problems of estimating the covariance matrices.

$$p ( i \vert {x}_{t} , λ ) = \frac{{w}_{i} \cdot N \{ {x}_{t} \vert {μ}_{i} , {Σ}_{i} \}}{{\sum }_{i = 1}^{M} {w}_{i} \cdot N \{ {x}_{t} \vert {μ}_{i} , {Σ}_{i} \}}$$

$${n}_{i} = {\sum }_{t = 1}^{T} p ( i \vert {x}_{t} , λ )$$

$${\hat{w}}_{i} = \frac{{n}_{i}}{T}$$

$${\hat{μ}}_{i} = \frac{1}{{n}_{i}} {\sum }_{t = 1}^{T} p ( i \vert {x}_{t} , λ ) \cdot {x}_{t}$$

FIG. 3, shows an exemplary MAP adaptation. On a left-hand side, the clusters of the UBM are shown with some feature vectors (corresponding to the crosses). Following the adaptation, the adapted or modified GMM clusters are shown on the righthand side. The new GMM parameters μ̅ and w̅ are determined as a combination of the previous GMM parameters μ and w and the updates \hat{μ} and ŵ. When the updates ŵ and \hat{μ} are determined, a weighted averaging is executed through the previous values. The previous values are weighted with a factor 1−α, and the updates with the factor α i.

$${α}_{i} = \frac{{n}_{i}}{{n}_{i} + const .}$$

$${\overline{μ}}_{i} = {μ}_{i} \cdot ( 1 - {α}_{i} ) + {\hat{μ}}_{i} \cdot {α}_{i}$$

$${\overline{w}}_{i} = \frac{{w}_{i} ( 1 - {α}_{i} ) + {\hat{w}}_{i} \cdot {α}_{i}}{{\sum }_{i = 1}^{M} ( {w}_{i} \cdot ( 1 - {α}_{i} ) + {\hat{w}}_{i} \cdot {α}_{i} )}$$

By the factor α, a weighting across the number of “softly” assigned feature vectors is obtained so that the adaptation is proportional to the number of assigned vectors. Clusters with a small number of adaptation data may be adapted at slower rates than clusters for which a large number of vectors. The factor α need not be the same for the weights and means in the same cluster. The sum of the weights may be equal to 1 or about 1.

Using a Bayesian Information Criterion (BIC), a BIC adaptation is performed on the UBM for the current speech segment, the previous speech segment (as buffered) and the unified segment containing both. Based on the resulting a posteriori probabilities, likelihood functions are determined for the hypotheses H₀ (no speaker change) and H₁ (speaker change):

$${L}_{0} = \frac{1}{{M}_{x} + {M}_{y}} ( {\sum }_{i = 1}^{Mx} log ( p ( {x}_{i} \vert {λ}_{z} ) ) + {\sum }_{i = 1}^{My} log ( p ( {y}_{i} \vert {λ}_{z} ) ) )$$

$${L}_{1} = \frac{1}{{M}_{x} + {M}_{y}} ( {\sum }_{i = 1}^{Mx} log ( p ( {x}_{i} \vert {λ}_{x} ) ) + {\sum }_{i = 1}^{My} log ( p ( {y}_{i} \vert {λ}_{y} ) ) )$$

A difference of the likelihood functions L₀-L₁ may be used as a parameter to determine whether a speaker change has occurred. In view of this, the likelihood functions and/or the difference are executed by the control component 804.

Besides a likelihood comparison, other methods may be executed when detecting speaker changes. A Kullback-Leibler distance divergence or a Hotelling distance may be used to determine distances or divergence between the resulting probability distributions.

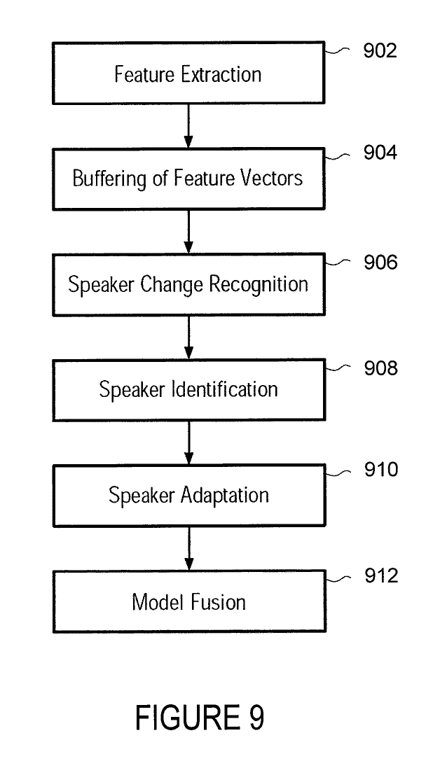

At 908, a speaker identification component 810 may identify a speaker. In this method, the segment of the current received utterance is processed to determine likelihood functions with respect to each speaker model within the speaker model set. At start-up, the speaker model set may include the UBM. In time, additional speaker models will be created and used to identify speech. The method shown in FIG. 9 searches for the most similar speaker model with index k representing the current utterance according to likelihood functions. The index j corresponds to the different speaker models, so that the best matching speaker model may be given by

$$k = {argmax}_{j} \{ \frac{1}{N} \sum log ( p ( {x}_{t} \vert {λ}_{j} ) ) \}$$

To determine whether the received utterance corresponds to a speaker model belonging to the speaker model set, a comparison of the likelihood for the k-th speaker and a predetermined threshold may be performed. If the likelihood falls below this threshold, the method determines that the current utterance does not belong to the existing speaker models.

The current speaker may not be recognized by only comparing the likelihood functions described above. Different likelihood functions may also be processed by the speaker identification component 908 and control component 804. These likelihood functions are processed, with the likelihood functions processed by the speaker change component 808, as additional parameters.

In some processes, information related to the training status of speaker-dependent models such as the distance between the speaker models, pitch, SNR and external information (e.g. direction of arrival of the incoming speech signals measured by an optional beamformer) may be processed. These different parameters and optionally their time history may be processed to determine whether an utterance stems from a known speaker. For this and other purposes (e.g., model selection, speaker recognition, etc.), the control component 804 may comprise interconnected processing elements that process a limited number of inputs and interface one or more outputs. The processing elements are programmed to ‘learn’ by processing weighted inputs that, with adjustment, time, and repetition may generate a desired output that is retained in the local or remote memories. In alternative systems the control component 804 comprises a type of artificial-intelligence system modeled after the neurons (nerve cells) in a biological nervous system like a neural network.

At 910 a speaker adaptation occurs through a speaker adaptation component 812. When a known speaker is identified by a control component 804, a selected speaker model belonging to a speaker model set is adapted through a Maximum A Posteriori process. When no match has been detected, a new speaker model may be created. The speaker model may be created through a MAP process on the speaker-independent universal background model. An adaptation size given by the factor a above may be controlled depending on the reliability of the speaker recognition as determined by control component 804. In some processes, the size may be reduced if accuracy or reliability is low.

The number of speaker models that are part of a speaker model set may be limited to a predetermined number. When a maximum number of speaker models is reached and a new speaker model is to be created, an existing speaker model may be selected which has not been adapted for a predetermined time or which had not been adapted for a predetermined time (e.g., a longest time).

Optionally, a model fusion at 912 may be executed in a model fusion component 814. At 912, the distance between two speaker models are measured to identify two speaker models belonging to a same or common speaker. Duplicate models may be identified. The process may further determine whether an adaptation of a speaker-dependent speaker model (if an utterance has been determined as corresponding to a known speaker) is an error. For this process, the distance between a speaker model before and after an adapting may be determined. This distance may be further processed as a parameter in the speaker recognition method.

Distance may be determined in two or more different ways. Some processes execute, a Kullback-Leibler entropy using a Monte Carlo simulation. For two models with the parameters λ₁ and λ₂, this entropy may be determined for a set of feature vectors yₜ, t=1, . . . , T as

$$KL ( {λ}_{1} \vert \vert {λ}_{2} ) = E \{ p ( {y}_{t} \vert {λ}_{1} ) \cdot log [ \frac{p ( {y}_{t} \vert {λ}_{1} )}{p ( {y}_{t} \vert {λ}_{2} )} ] \}$$

The expectation value E{·} may be approximated by a Monte Carlo simulation. Alternatively, a symmetrical Kullback-Leibler entropy KL(λ₁∥λ₂)+KL(λ₂∥λ₁) may be processed to measure the separation between the models. In other processes, cross-correlation of the models may be used. A predetermined number of feature vectors xₜ, t=1, . . . T may be created randomly from two GMMs with parameters λ₁ and λ₂. The likelihood functions of both GMMs may be determined and the correlation coefficient calculated by

$${ρ}_{1 , 2} = \frac{{\sum }_{t = 1}^{T} p ( {x}_{t} \vert {λ}_{1} ) \cdot p ( {x}_{t} \vert {λ}_{2} )}{\sqrt{( {\sum }_{t = 1}^{T} {p}^{2} ( {x}_{t} \vert {λ}_{1} ) ) \cdot ( {\sum }_{t = 1}^{T} {p}^{2} ( {x}_{t} \vert {λ}_{2} ) )}}$$

Irrespective of how distance is measured, the distances (e.g., after some normalization) are processed by the control component 804. The control component 804 may determine whether two models should be combined or fused. When combined, a fusion of the weights and means like a MAP process, may be executed:

$${α}_{i} = \frac{{n}_{i , {λ}_{2}}}{{n}_{i , {λ}_{2}} + {n}_{i , {λ}_{1}}}$$

$${\overline{μ}}_{i} = {μ}_{i , {λ}_{1}} \cdot ( 1 - {α}_{i} ) + {μ}_{i , {λ}_{2}} \cdot {α}_{i}$$

$${\overline{w}}_{i} = \frac{{w}_{i , {λ}_{1}} \cdot ( 1 - {α}_{i} ) + {w}_{i , {λ}_{2}} \cdot {α}_{i}}{{\sum }_{i = 1}^{M} ( {w}_{i , {λ}_{1}} \cdot ( 1 - {α}_{i} ) + {w}_{i , λ} \cdot {α}_{i} )}$$

The covariance matrices need not be combined or fused as only the weights and mean vectors are adapted in the MAP algorithm. n_{t,λ}_{₁} may be the number of all feature vectors which have been used for adaptation of the cluster i since creation of model λ₁, n_{i,λ}_{₂} may be selected.

Besides the combination or a fusion of two models, this distance determination may also be processed by the control component 804 to determine whether a new speaker model should be created. Other parameters may also be processed when deciding to create speaker models. Parameter may be obtained by modeling the detected background noise detected and processed by the optional background model component 816. The system may account desired foreground and unwanted background speech. In some processes an exemplary background speech modelling applies confidence measures reflecting the reliability of a decision based on noise distorted utterances. A speaker model

λ₁={w,μ,Σ}

may be extended by a background model

$${λ}_{2} = \{ \tilde{w} , \tilde{μ} , \tilde{Σ} \} to a total model λ = \{ ( \begin{matrix}w \\ \tilde{w}\end{matrix} ) , ( μ \tilde{μ} ) , ( Σ \tilde{Σ} ) \} .$$

w, \tilde{w} are vectors comprising the weights of the speaker dependent and background noise models whereas μ, \tilde{μ} and ρ, \tilde{Σ} represent the mean vectors and covariance matrices. Besides one speaker-dependent model λ₁, a group of speaker-dependent models or the speaker-independent model λ_{UBM} maybe extended by the background noise model. A posteriori probability of the total GMM applied only to the clusters of GMM λ₁, will have the form

$$p ( i \vert {x}_{t} , λ ) = \frac{{w}_{i} \cdot N \{ {x}_{t} \vert {μ}_{i} , {Σ}_{i} \}}{{\sum }_{i = 1}^{M} {w}_{i} \cdot N \{ {x}_{t} \vert {μ}_{i} {Σ}_{i} \} + {\sum }_{j = 1}^{P} {\tilde{w}}_{j} \cdot N \{ {x}_{t} \vert {\tilde{μ}}_{j} , {\tilde{Σ}}_{j} \}}$$

The a posteriori probability of GMM λ₁ may be reduced due to the uncertainty of the given feature vector with respect to the classification into speaker or background noise. This results in a further parameter of the speaker adaptation control 812.

In some processes, only the parameters of the speaker λ₁ are adapted. After the adaptation, the total model may be split into the models λ₁ and λ₂ where the weights of the models λ, λ₁ and λ₂ are normalized so as to sum up to 1 or about 1.

It is also possible to perform an adaptation of the background noise model by applying the above-described method to model λ₂. By introducing a threshold for the a posteriori probability of the background noise cluster (as a programmed threshold for which determining whether a vector is used for adaptation with a weight not being equal to zero), an adjustment of both models may be avoided. Such a threshold may be justified when a much larger number of feature vectors are present for the background noise model than the speaker-dependent models. A slower adaptation of the background noise model may be desirable.

The process determines a plurality of parameters or variables which may be processed or applied as criteria to determine whether a received utterance corresponds to a prior speaker model belonging to a speaker model set. For this purpose, the control component 804 may receive different input data from local or remote devices that generate signal-to-noise ratios, pitch, direction information, length of an utterance and difference in time between utterances from one or more acoustic pre-processing component. Other data or information may be processed including the similarity of two utterances from the speaker change recognition component, likelihood values of known speakers and of the UBM from the speaker identification component 810, distances between speaker models, estimated a priori probabilities for the known speakers, a posteriori probabilities that a feature vector stems from the background noise model.

External information like a system restart, current path in a speech dialog, feedback from other manual machine interactions (such as multimedia applications), or technical (or automated) devices (such as keys in an automotive environment, wireless devices, mobile phones or other electronic devices assigned to a specific user) may interface the automatic speech recognition system or communicate with the automatic speech recognition process.

Based on some or all of these input data, the control component 804 may make one or more decisions. The decisions may indicate whether a speaker change occurred (e.g. by fusing the results from the speaker change recognition and the speaker identification), the identity of the speaker (in-set speaker), an unknown speaker was detected (out-of-set speaker), or the identity of one or more models associated with a speaker. Other decisions may avoid incorrect adaptations to known speaker models, evaluate the reliability of specific feature vectors that may be associated with a speaker or the background noise, determining a reliability of a decision favoring a speaker adaptation. Other decisions estimate a priori probability of the speaker, adjust programmable decision thresholds, and/or taking into account decisions and/or input variables from the past.

These decisions and determinations may be made in many ways. Different parameters (such as likelihoods) received from a different component may be combined in a predetermined way, for example, using pre-programmed weights. Alternatively, a neural network may process parameters to reach these decisions. In some processes, a neural network may be permanently adapted

In some processes, a set or pool of models may be stored with a speaker independent model (UBM) before start-up. These models may be derived from a single UBM so that the different classes may be compared. An original UBM may be adapted to one or more classes of speakers so that unknown speakers may be assigned to a prior adapted UBM. The assignment may occur when the speaker is classified into one of the speaker classes (e.g., male or female). Through these processes a speaker that is new to the system may adapt the speaker's dependent models at a faster rate than if there were no class divisions.

The systems may process speaker-independent models that may be customized by a speaker's short utterances without high storage requirements and without a high computational load. By fusing some or all of the appropriate soft decisions at one or more stages, the systems accurately recognize a user's voice. Through its speaker model selection and historical time analysis, the automatic speech recognition system may detect, and/or avoid or correct false decisions.

Other alternate systems and methods may include combinations of some or all of the structure and functions described above or shown in one or more or each of the figures. These systems or methods are formed from any combination of structures and function described or illustrated within the figures.

The methods and descriptions above may be encoded in a signal bearing medium, a computer readable medium or a computer readable storage medium such as a memory that may comprise unitary or separate logic, programmed within a device such as one or more integrated circuits, or processed by a controller or a computer. If the methods or descriptions are performed by software, the software or logic may reside in a memory resident to or interfaced to one or more processors or controllers, a communication interface, a wireless system, a powertrain controller, body control module, an entertainment and/or comfort controller of a vehicle or non-volatile or volatile memory remote from or resident to the a speech recognition device or processor. The memory may retain an ordered listing of executable instructions for implementing logical functions. A logical function may be implemented through digital circuitry, through source code, through analog circuitry, or through an analog source such as through an analog electrical, or audio signals.

The software may be embodied in any computer-readable storage medium or signal-bearing medium, for use by, or in connection with an instruction executable system or apparatus resident to a vehicle or a hands-free or wireless communication system. Alternatively, the software may be embodied in a navigation system or media players (including portable media players) and/or recorders. Such a system may include a computer-based system, a processor-containing system that includes an input and output interface that may communicate with an automotive, vehicle, or wireless communication bus through any hardwired or wireless automotive communication protocol, combinations, or other hardwired or wireless communication protocols to a local or remote destination, server, or cluster.

A computer-readable medium, machine-readable storage medium, propagated-signal medium, and/or signal-bearing medium may comprise any medium that contains, stores, communicates, propagates, or transports software for use by or in connection with an instruction executable system, apparatus, or device. The machine-readable storage medium may selectively be, but not limited to, an electronic, magnetic, optical, electromagnetic, infrared, or semiconductor system, apparatus, device, or propagation medium. A non-exhaustive list of examples of a machine-readable medium would include: an electrical or tangible connection having one or more links, a portable magnetic or optical disk, a volatile memory such as a Random Access Memory “RAM” (electronic), a Read-Only Memory “ROM,” an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled by a controller, and/or interpreted or otherwise processed. The processed medium may then be stored in a local or remote computer and/or a machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method that automatically recognizes speech based on a received speech input, comprising:
accessing a speaker model set comprising one or more speaker-independent speaker models;
detecting whether the received speech input matches a speaker model of the speaker model set according to an adaptable predetermined criterion; and
creating a speaker model for the speaker model set when no match occurs based on the received speech input.

2. The method of claim 1 where the act of detecting comprises performing a speaker change recognition to detect speaker changes where the predetermined criterion comprises speaker change characteristics.

3. The method of claim 2 where the act of detecting comprises determining a measure that identifies a speaker with respect to the speaker models that belong to the speaker model set where the predetermined criterion comprises speaker identification characteristics.

4. The method of claim 3 where each speaker model comprises a Gaussian mixture model.

5. The method of claim 3 where the act of detecting comprises executing a likelihood function.

6. The method of claim 3 where the act of detecting is based on a Bayesian Information Criterion.

7. The method of claim 3 where the speaker-independent model comprises a Universal Background Model.

8. The method of claim 3 where the act of creating comprises adapting the speaker-independent model to create a new speaker model.

9. The method of claim 8 where the act of adapting comprises performing a Maximum A Posteriori process.

10. The method of claim 1 further comprising adapting a speaker model in the speaker model set when a match is detected.

11. The method of claim 10 further comprising comparing a speaker model in the speaker model set before and after the adapting step according to a predetermined criterion.

12. The method of claim 10 further comprising determining whether two speaker models that belong in the speaker model set correspond to a same speaker according to a second predetermined criterion.

13. The method of claim 10 where the act of detecting is based on a background noise model.

14. The method of claim 1 where the act of detecting is based on a background noise model.

15. The method of claim 1 further comprising monitoring an input to detect a change in speakers and modifying the adaptable predetermined criteria when the change occurs.

16. A computer-readable storage medium that stores instructions that, when executed by processor, cause the processor to recognize speech by executing software that causes the following act comprising:
digitizing a speech signal representing a verbal utterance;
accessing a speaker model set comprising one or more speaker-independent speaker models;
detecting whether the received speech input signal matches a speaker model of the speaker model set according to an adaptable predetermined criterion; and
creating a speaker model for the speaker model set when no match occurs based on the received speech input.

17. A system that automatically recognizes a speaker based on a received speech input, comprising:
a database that retains a speaker model set comprising a speaker model that is speaker-independent;
a detecting component that detects whether the received speech input matches a speaker model of the speaker model set according to an adaptable predetermined criterion; and
a creating component that creates a speaker model assigned to the speaker model set based on the received speech input when no match is detected.

18. The system of claim 17 where the detecting component comprises a control component.

19. The system of one claim 18 where the detecting component comprises a speaker change recognition component that is programmed to recognize speaker change where the adaptable predetermined criterion is based on a measure of a speaker change.

20. The system of claim 19 where the detecting component comprises a speaker identification component that identifies a speaker based on the speaker model in the speaker model set where the predetermined criterion is based on identifying characteristics.
